(19) United States
(12) Patent Application Publication
(10) Pub. No.: US 2012/0256013 A1
(43) Pub. Date: Oct. 11, 2012

(54) INJECTION VALVE

(75) Inventors: Robert Giezendanner-Thoben, Gerlingen (DE); Anton Dukart, Gerlingen (DE); Olaf Ohlhafer, Erlingheim (DE); Dirk Schmidt, Kirchheim (DE)

(73) Assignee: ROBERT BOSCH GMBH, Stuttgart (DE)

(21) Appl. No.: 13/518,008

(22) PCT Filed: Sep. 3, 2010
(86) PCT No.: PCT/EP10/64584

§ 371 Date: Jun. 26, 2012

(30) Foreign Application Priority Data
Dec. 21, 2009 (DE) 102009055042.9

(51) Int. Cl. B05B 1/08

(52) U.S. Cl. 239/102.1

(57) ABSTRACT

The invention relates to an injection valve (1), which is used in particular as an injector for fuel injection systems or exhaust gas aftertreatment systems, comprising a shock wave actuator (4), a valve closing body (8) that interacts with a valve seat surface (7) to form a sealing seat (9), and a shock wave amplification channel (22). The shock wave amplification channel (22) is used to conduct shock waves (27) generated by the shock wave actuator (4) to the sealing seat (9) and to amplify said shock waves (27).

### BACKGROUND OF THE INVENTION

The invention relates to an injection valve, in particular an injector for fuel injection systems or for exhaust-gas aftertreatment systems.

DE 10 2006 026 153 A1 has disclosed a spray device for fluids. The known spray device has a nozzle and an actuator for regulating the fluid flow through the nozzle outlet. Moreover, a shock-wave actuator is provided for generating shock waves in the fluid which is situated in the nozzle. Shock waves are generated in the spray device via the shock-wave actuator, which shock waves are guided onto the fluid which is situated in the nozzle.

In the case of a spray device for fluids having a shock-wave actuator, the problem arises that operation has to be carried out counter to an ambient pressure which is produced, for example, by the pressure in the combustion chamber. Moreover, problems arise in the jet shaping.

### SUMMARY OF THE INVENTION

In contrast, the injection valve according to the invention has the advantage that injection behavior is improved. Specifically, defined injection jets can be realized and opening of the injection valve can be realized which is at least largely independent of the ambient pressure, in particular the combustion chamber pressure.

In an advantageous way, the shock-wave actuating system generates shock waves which are guided to the sealing seat. The physical phenomenon of the shock wave is a strong pressure wave in elastic media, such as liquids, which can propagate at supersonic speed, high mechanical stresses and pressures prevailing at the shock front of the shock wave. The shock wave represents a pressure pulse, in which the pressure rises steeply within a fraction of a second and subsequently drops steeply again. The extreme pressure change which is generated by the pressure wave has its effect amplified further by the shock-wave amplifying channel. As a result, the valve closing body can be raised up from the valve seat face in an advantageous way, in order to open the sealing seat which is formed between the valve closing body and the valve seat face. As a result, very high injection pressures can be realized, in order to realize advantageous atomization even at high ambient pressures. For example, fuel can be injected into the combustion chamber of an internal combustion engine at a pressure of approximately 200 MPa (2000 bar) for direct diesel injection or of 20 MPa (200 bar) for direct gasoline injection. Here, firstly defined, individual injection jets can be realized. Secondly, opening of the injection valve can be achieved which is independent of the combustion chamber pressure or another ambient pressure.

It is advantageous that a cross-sectional area of the shock-wave amplifying channel, which cross-sectional area remains free and serves to guide the shock waves, decreases at least in sections from the shock-wave actuating system toward the sealing seat. Here, the cross-sectional area which remains free preferably decreases uniformly toward the sealing seat. As a result, advantageous amplifying of the shock wave occurs, said shock wave exerting a high local pressure at the sealing seat and therefore a great opening force on the valve closing body.

Furthermore, it is advantageous that an injector body is provided which has at least one internal space, that a shock-wave amplifying element is inserted into the internal space, that the shock-wave amplifying channel is configured at least in sections between an inner wall of the internal space and the shock-wave amplifying element, and that a tip of the shock-wave amplifying element is oriented in the shock-wave amplifying channel counter to a propagation direction of the shock waves which are generated. The shock wave which is generated by the shock-wave actuating system runs in the direction of the sealing seat. Here, the shock-wave front will penetrate at the tip of the shock-wave amplifying element. The shock-wave amplifying channel narrows behind the tip, with the result that the shock wave is amplified increasingly. Furthermore, it is advantageous here that, between the inner wall of the internal space and the shock-wave amplifying element, the shock-wave amplifying channel is of annular configuration at least in sections and/or is of partly annular configuration at least in sections and/or is configured at least in sections as a multiply interrupted ring. In addition or as an alternative, it is advantageous that the shock-wave amplifying element is configured at least approximately as a conical shock-wave amplifying element, and/or that the inner wall of the internal space tapers at least in sections from the shock-wave actuating system toward the sealing seat. Furthermore, it is advantageous that the inner wall of the internal space is of conical configuration at least in sections. As a result, the shock-wave amplifying channel can advantageously be configured as a narrowing annular gap which is optionally divided into sections. Here, the annular gap preferably narrows more and more in the direction of the sealing seat, with the result that the shock wave is amplified increasingly. In the region of the sealing seat, a high pressure of the shock wave, which high pressure leads to the opening of the sealing seat, then acts at least approximately uniformly in a manner distributed over the sealing seat.

Furthermore, it is advantageous that the valve closing body is formed on the shock-wave amplifying element. Here, the shock-wave amplifying element can be configured in one part or multiple parts. In the case of a multiple part configuration, the individual parts are connected to one another in a suitable way. Here, it is also advantageous that at least one guide element is provided for the shock-wave amplifying element, which guide element is arranged in the internal space of the injector body. As a result, guidance of the guide element is ensured, for example, along a longitudinal axis of the injection valve.

Furthermore, it is advantageous that a spring element is provided which loads the valve closing body against the sealing seat. Here, the opening force on the valve closing body, which opening force is induced by the shock wave on account of the high local pressure at the sealing seat, acts counter to a prestress of the spring element. As a result, tuning of the injection valve can be performed.

It is also advantageous that the valve closing body has at least one pressure equalization channel. As a result, hydraulic damping of the valve closing body is avoided during an opening movement.

It is advantageous that the shock-wave actuating system has an electrically conductive, elastic diaphragm and at least one field coil, and that the field coil is assigned to the diaphragm in order to generate an induction current in the diaphragm. Via the field coil, an induction current can be generated in the diaphragm. The interaction of the magnetic field of the field coil and the induced magnetic field which is generated by the induction current in the diaphragm leads to a force on the diaphragm. As a result, bending of the diaphragm occurs. As a result of the bending of the diaphragm, a shock wave is generated in the medium which adjoins the diaphragm. Said shock wave then runs from the diaphragm through the shock-wave amplifying channel to the sealing seat.

It is advantageous that the diaphragm is configured as an at least approximately circular diaphragm, and that the field coil is arranged in the region of a side of the diaphragm, which side faces away from the shock-wave amplifying channel. Upon the actuation of the shock-wave actuating system, a repulsion force is generated on the basis of the magnetic field of the coil and the induced magnetic field in the diaphragm. Here, an induction current (eddy current) occurs in the diaphragm, which induction current is oriented such that it opposes the current through the field coil.

However, it is also advantageous that the diaphragm is configured as a tubular and/or conical diaphragm, that an inner side of the diaphragm delimits the shock-wave amplifying channel, and that the field coil is arranged in the region of an outer side of the diaphragm. As a result, the area of the diaphragm which serves to generate the shock wave can be increased in relation to an available installation space.

The diaphragm is preferably configured as a metal diaphragm. In particular, the metal diaphragm can be formed at least substantially from copper. A diaphragm can also be formed from at least two components which serve to seal and to make the excitation possible. For example, the diaphragm can be formed from at least one precious metal, in particular platinum, and copper. The diaphragm can also be formed from a ferromagnetic steel sheet. In order to improve the conductivity of the diaphragm, a ferromagnetic steel sheet which is coated with copper or the like toward the field coil can also be used as diaphragm.

### BRIEF DESCRIPTION OF THE DRAWINGS

Preferred exemplary embodiments of the invention are explained in greater detail in the following description with reference to the appended drawings, in which corresponding elements are provided with coinciding designations and in which:

FIG. 1 shows a first exemplary embodiment of an injection valve of the invention in a partial, diagrammatic sectional illustration, and

FIG. 2 shows a second exemplary embodiment of an injection valve of the invention in a partial, diagrammatic sectional illustration.

### DETAILED DESCRIPTION

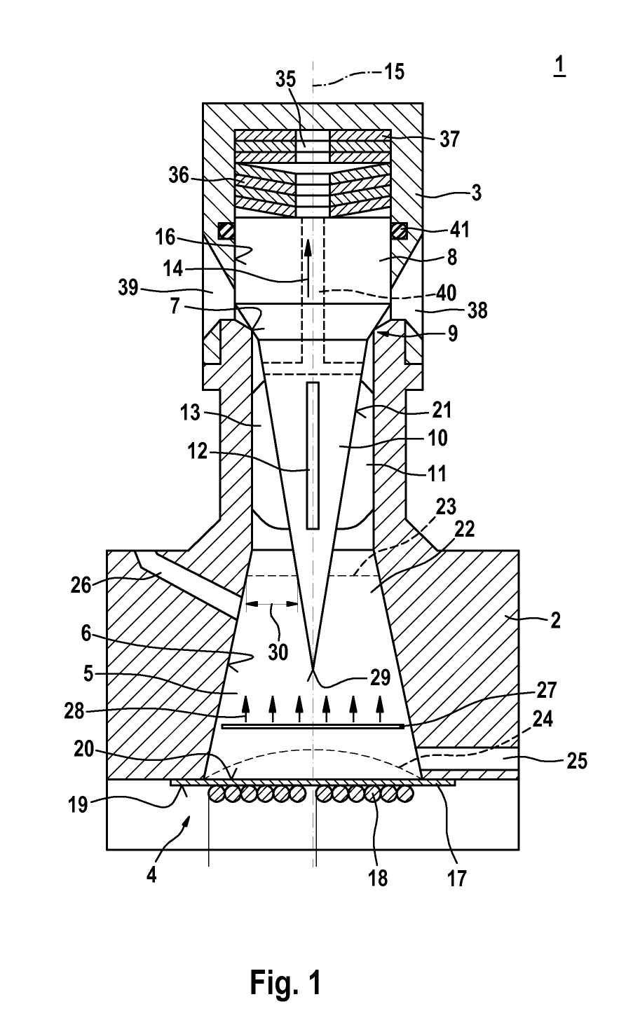

FIG. 1 shows a first exemplary embodiment of an injection valve 1 in a partial, diagrammatic sectional illustration. The injection valve 1 can serve, in particular, as an injector 1 for fuel injection systems. An injector 1 of this type can be used for air-compressing, compression-ignition internal combustion engines or for mixture-compressing, spark-ignition internal combustion engines. Specifically, the injection valve 1 can serve for the injection of diesel fuel or of gasoline into a combustion chamber of an internal combustion engine. However, the injection valve 1 can also be used for an exhaust-gas aftertreatment system, for example for the injection for DeNOx systems. However, the injection valve 1 according to the invention is also suitable for other applications.

The injection valve 1 has an injector body 2, an injector sleeve 3 which is connected to the injector body 2, and a shock-wave actuating system 4. Here, the shock-wave actuating system 4 is arranged in the injector body 2. Moreover, the injector body 2 has an internal space 5. Here, the internal space 5 is delimited by an inner wall 6 of the injector body 2.

A valve seat face 7 is formed on the injector body 2. Moreover, a valve closing body 8 which is assigned to the valve seat face 7 is provided, which valve closing body 8 interacts with the valve seat face 7 to form a sealing seat 9. Furthermore, a shock-wave amplifying element 10 is provided which is arranged at least partially in the internal space 5 of the injector body 2. Here, a plurality of guide elements 11, 12, 13 are provided which hold the shock-wave amplifying element 10. Here, the guide elements 11, 12, 13 are connected to the injector body 2.

In this exemplary embodiment, the valve closing body 8 is formed on the shock-wave amplifying element 10. Here, a single part or multiple part embodiment of the shock-wave amplifying element 10 with the valve closing body 8 is possible. In this case, the guide elements 11, 12, 13 make an adjustment of the shock-wave amplifying element 10 and therefore also of the valve closing body 8 possible from the starting position (shown in FIG. 1) in an opening direction 14 along an axis 15 of the injection valve 1. Here, moreover, the valve closing body 8 and therefore also the shock-wave amplifying element 10 are guided on a guide hole 16 of the injector sleeve 3.

The shock-wave actuating system 4 comprises an electrically conductive, elastic diaphragm 17 or a piston. Here, the diaphragm 17 can be configured as a metal diaphragm 17. The metal diaphragm 17 can be formed from a metal or else from a plurality of metals. For example, the metal diaphragm 17 can be formed from a steel foil with a copper coating. The shock-wave actuating system also comprises a field coil 18. The field coil 18 is assigned to the diaphragm 17 and is arranged on a side 19 of the diaphragm 19 which is of circular configuration in this exemplary embodiment. If the metal diaphragm 17 has a copper coating, said copper coating preferably faces the field coil 18 and is therefore provided on the side 19. Moreover, the diaphragm 17 has a further side 20 which faces away from the side 19.

The side 20 of the diaphragm 17, the inner wall 6 of the internal space 5 and an outer side 21 of the shock-wave amplifying channel 10 delimit a shock-wave amplifying channel 22. The shock-wave channel 22 extends from the diaphragm 17 of the shock-wave actuating system 4 as far as the sealing seat 9. The shock-wave amplifying channel 22 has a cross-sectional area 23 which remains free, serves to guide shock waves and is oriented perpendicularly with respect to the axis 15. In the region of the shock-wave amplifying element 10, the cross-sectional area 23 which remains free is configured to be annular or as a multiply interrupted ring, as is the case in the region of the guide elements 11, 12, 13.

Upon actuation of the diaphragm 17 by means of the field coil 18, the diaphragm 17 arches into the internal space 5, as is illustrated by a broken line 24. The injector body 2 has an inflow channel 25 and an outflow channel 26. A medium, in particular fuel, is guided into the internal space 5 via the inflow channel 25. The medium can be guided out of the internal space 5 via the outflow channel 26. As a result, bubbles which are produced or the like can also be guided out of the internal space 5. During operation of the injection valve 1, the shock-wave amplifying channel 22 is filled completely with the medium. Upon actuation of the diaphragm 17, a shock wave 27 is generated in the medium, which shock wave 27 is of approximately planar configuration in this exemplary embodiment. The shock wave 27 propagates in a direction 28 in the medium and therefore runs from the diaphragm 17 through the shock-wave amplifying channel 22 to the sealing seat 9.

The shock-wave amplifying element 10 is of conical configuration. The shock-wave amplifying element 10 can also be configured such that it is exponentially shaped. Here, a tip 29 of the shock-wave amplifying element 10 is directed at the center of the diaphragm 17. The shock-wave amplifying element 10 is of symmetrical configuration with regard to the axis 15. In the region of the shock-wave amplifying element 10, a width 30 of the annular cross-sectional area 23 which remains free decreases in the direction 28 as far as the sealing seat 9. Furthermore, the cross-sectional area 23 which remains free also decreases between the diaphragm 17 and the tip 29. The cross-sectional area 23 is of circular configuration between the diaphragm 17 and the tip 29.

After the deflection of the diaphragm 17 in order to generate the shock wave 27 with the aid of the shock-wave actuating system 4, the shock wave 27 runs in the direction 28 to the shock-wave amplifying element 10. The conical shock-wave amplifying element 10 penetrates the planar shock wave front of the shock wave 27 with its tip 29. Here, the shock-wave amplifying element 10 is configured in such a way that only a minimum part of the shock wave 27 is reflected at the tip 29. Correspondingly, the guide elements 11, 12 13 are also configured in such a way that reflections are avoided as far as possible. Since the cross-sectional area 23 which remains free, in particular the width 30 of the annular cross-sectional area 23, and therefore the area of the shock wave front 27 decrease in the direction 28, the shock wave 27 is amplified in the narrowing shock-wave amplifying channel 22.

When the amplified shock wave reaches the sealing seat 9, a force is exerted on the valve closing body 8 in the opening direction 14 on account of the high local pressure. The magnitude of the force can be set via the given area ratios and angles of the level of the valve closing body 8 and the area in the region of the sealing seat 9.

A spring element 36 in the form of a disk spring assembly and a setting means 37 in the form of adjustment disks are arranged in an internal space 35 of the injector sleeve 3. The spring element 36 is prestressed, with the result that the valve closing body 8 is pressed, counter to the opening direction 14, with a prestress against the valve seat face 7. If the opening force which acts on the valve closing body 8 as a result of the amplified shock wave 27 exceeds the closing force of the spring element 36, the valve closing body 8 is adjusted in the opening direction 14. As a result, opening of the sealing seat 9 and therefore the discharge of the medium out of the internal space 5 via spray holes 38, 39 occur. Here, as a result of the shock wave, atomization of the medium into the surrounding space, in particular a combustion chamber of an internal combustion engine, can be achieved.

The valve closing body 8 has a pressure equalization channel 40, with the result that hydraulic damping of the valve closing body 8 is avoided during the opening movement.

After the amplified shock wave has left the pressure-active regions of the valve closing body 8 at the sealing seat 9, the closing force of the spring element 36 predominates again, with the result that the valve closing body 8 is adjusted counter to the opening direction 14 and the sealing seat 9 is closed again by placing the valve closing body 8 on the valve seat face 7. The medium which is discharged via the spray holes 38, 39 during the injection operation is replaced via the inflow channel 25. Here, a continuous flow of the medium to be injected via the inflow channel 25 and the outflow channel 26 can be achieved, gas bubbles which are possibly formed being conveyed out of the internal space 5. The injection valve 1 is therefore prepared for the next injection.

In this exemplary embodiment, a sealing ring 41 which seals the internal space 35 of the injector sleeve 3 is provided on the guide hole 16. The sealing ring 41 is formed from a temperature-resistant material which is resistant, for example, up to a maximum combustion chamber temperature. The pressure of the medium in the internal space 4 can lie, for example, in a range between 100 kPa (1 bar) and 500 kPa (5 bar).

The injection valve 1 can therefore generate individual injection jets in a defined manner. Specifically, a sufficient pressure is generated in a reliable way, in order to generate, for example, a reliable injection against a great combustion chamber pressure.

A very rapid, explosive discharge of the stored energy quantity is required for the shock-wave generation by way of the shock-wave amplifying element 10. Here, an energy quantity of approximately 20 J can be discharged in a time of a few microseconds, which corresponds to a power output of a few MW. In the case of ferromagnetic or piezoelectric actuators, the power densities are limited on account of the saturation effects of the ferromagnetism and the ferroelectric. Secondly, relatively great volumetric displacements are required, in order to convey and therefore inject a sufficient quantity of medium through the shock-wave amplifying channel 22.

The metal diaphragm 17 is therefore actuated inductively in this exemplary embodiment. Here, a brief current pulse is generated in the field coil 18 which is configured as a helical air-core coil. Said current pulse generates a magnetic field which induces an induction current in the conductive metal diaphragm 17 in the form of an eddy current which is directed counter to the coil current through the field coil 18. Here, the force which acts on the metal diaphragm 17 in accordance with the law of induction is greater, the shorter the spacing of the field coil 18 from the metal diaphragm 17. The field coil 18 is therefore arranged as near as possible to and preferably directly on the side 19 of the metal diaphragm 17. At a current rating of 1000 A, a force in the range of a few kN, for example, can act on the metal diaphragm 17. Relatively great deflections, in particular deflections of more than 1 mm, of the metal diaphragm 17 can be achieved by way of forces of this type, as is illustrated, for example, by the broken line 24.

The field coil 18 can also be attached to a cylindrical or conical circumferential face of a cylinder or cone, in order to increase the amplitude of the shock wave 27 by way of suitable wave concentrators.

The degree of efficiency for the purely magnetic coupling is approximately 75%. Part of the energy is converted into heat in the metal diaphragm 17 and is output to the medium in the region of the side 20. As a result of heating, an expansion of the medium occurs on the side 20 of the diaphragm 17, which leads as it were to a thermal wave which assists the generation process of the shock wave 27.

Moreover, the shock-wave actuating system 4 can realize a pump function. The metal diaphragm 17 or the piston is preferably formed from a ferromagnetic steel sheet which is coated with copper or the like toward the field coil 18 in order to improve the conductivity. After the quantity which is determined by the pulse of the current through the field coil 18 has been injected by actuation of the diaphragm 17, the diaphragm 17 can be pulled into the original position (shown in FIG. 1) by means of a direct current which is routed through the field coil 18 or by means of a low-frequency current at a frequency of less than 1 kHz. As a result, a vacuum which leads to the medium being sucked out of the inflow channel 25 is generated on the side 20 of the diaphragm 17.

In addition or as an alternative, the restoring function can also be realized by a restoring spring which acts on the diaphragm 17.

Fuels, in particular gasoline or diesel, urea for exhaust gas improvement or other media can therefore be ejected in a reliable way from the injection valve 1 via the spray holes 38, 39.

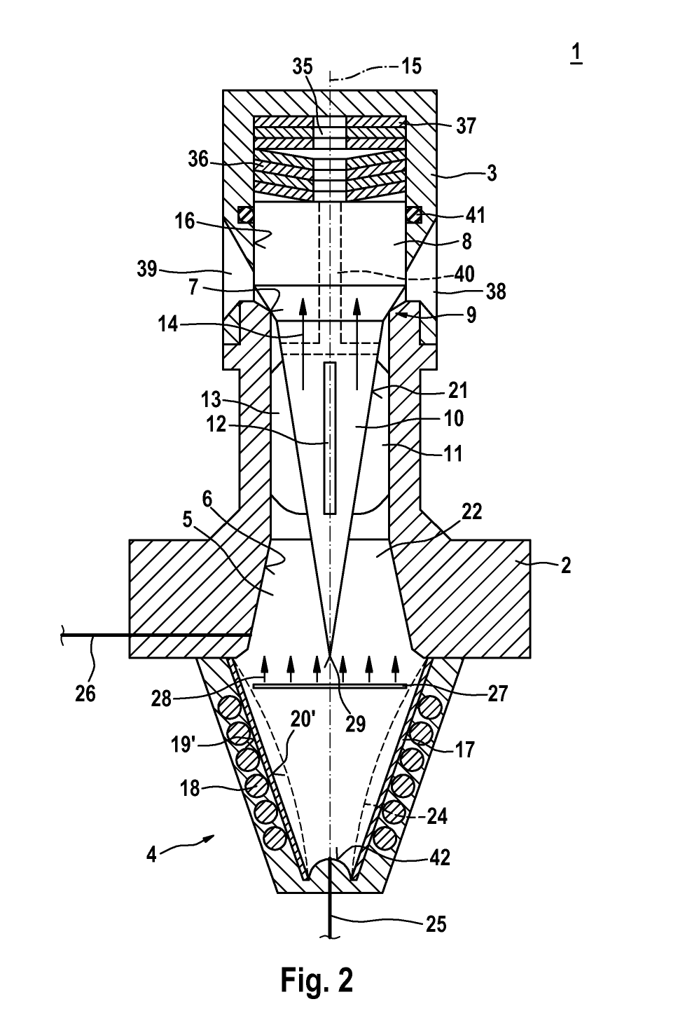

FIG. 2 shows an injection valve 1 in a partial, diagrammatic sectional illustration in accordance with a second exemplary embodiment. In this exemplary embodiment, the diaphragm 17 is configured as a tubular and conical diaphragm 17. Here, an inner side 20′ of the diaphragm 17 delimits the shock-wave amplifying channel 22. Furthermore, the field coil 18 is arranged in the region of an outer side 19′ of the diaphragm 17. In order to actuate the shock-wave actuating system, a current is routed through the field coil 18, which current generates an induction current (eddy current) in the diaphragm 17 and therefore leads to a repelling force on the diaphragm 17. As a result, the diaphragm 17 arches circumferentially in the direction of the axis 15. The generation of a shock wave 27 therefore occurs, which shock wave 27 propagates through the shock-wave amplifying channel 22 in the direction 28. The shock wave 27 is amplified in the shock-wave amplifying channel 22. The amplified shock wave runs as far as the sealing seat 9, as a result of which the ejection of the medium via the spray holes 38, 39 occurs.

In this embodiment, the amplitude of the shock wave 27 can be increased by way of suitable wave concentrators.

The inflow channel 25 can open into the internal space 5 at one end 42 of the internal space 5.

The invention is not restricted to the exemplary embodiments which have been described.

1. An injection valve (1), in particular an injector for fuel injection systems or for exhaust-gas aftertreatment systems, having a shock-wave actuating system (4), a valve closing body (8) which interacts with a valve seat face (7) to form a sealing seat (9), and a shock-wave amplifying channel (22) which serves to guide shock waves (27) which are generated by the shock-wave actuating system (4) to the sealing seat (9) and to amplify said shock waves (27), a cross-sectional area (23) of the shock-wave amplifying channel (22), which cross-sectional area (23) remains free and serves to guide the shock waves (27), decreasing at least in sections from the shock-wave actuating system (4) toward the sealing seat (9), an injector body (2) being provided which has at least one internal space (5), a shock-wave amplifying element (10) being inserted into the internal space (5), the shock-wave amplifying channel (22) being configured at least in sections between an inner wall (6) of the internal space (5) and the shock-wave amplifying element (10), and a tip (29) of the shock-wave amplifying element (10) being oriented in the shock-wave amplifying channel (22) counter to a propagation direction (28) of the shock waves (27) which are generated.

2. (canceled)

3. (canceled)

4. The injection valve as claimed in claim 1, characterized in that, between the inner wall (6) of the internal space (5) and the shock-wave amplifying element (10), the shock-wave amplifying channel (22) is at least one of annular configuration at least in sections, partly annular configuration in sections, and configured in sections as a multiple interrupted ring.

5. The injection valve as claimed in claim 1, characterized in that the valve closing body (8) is formed on the shock-wave amplifying element (10).

6. The injection valve as claimed in claim 5, characterized in that at least one guide element (11, 12, 13) is provided for the shock-wave amplifying element (10), which guide element (11, 12, 13) is arranged in the internal space (5) of the injector body (2).

7. The injection valve as claimed in claim 1, characterized in that the shock-wave actuating system (4) has one of an electrically conductive, elastic diaphragm (17) and a piston, and at least one field coil (18), and in that the at least one field coil is assigned to the diaphragm (17) in order to generate an induction current in the diaphragm (17) or is assigned to the piston in order to generate an induction current in the piston.

8. The injection valve as claimed in claim 7, characterized in that the one of the diaphragm (17) and the piston is configured as an at least approximately circular diaphragm (17) and as an at least approximately circular piston, respectively, and in that the field coil (18) is arranged in the region of a side (19) of the diaphragm (17) or the piston, which side (19) faces away from the shock-wave amplifying channel (22).

9. The injection valve as claimed in claim 7, characterized in that the diaphragm (17) is configured as at least one of a tubular and a conical diaphragm (17), in that an inner side (20′) of the diaphragm (17) delimits the shock-wave amplifying channel (22), and in that the field coil (18) is arranged in the region of an outer side (19′) of the diaphragm (17).

10. The injection valve as claimed in claim 7, characterized in that the diaphragm (17) is configured at least substantially as a metal diaphragm (17).

11. The injection valve as claimed in claim 1, characterized in that the shock-wave amplifying element (10) is configured at least approximately as a conical shock-wave amplifying element (10).

12. The injection valve as claimed in claim 1, characterized in that the inner wall (6) of the internal space (5) tapers at least in sections from the shock-wave actuating system (4) toward the sealing seat (9).

13. The injection valve as claimed in claim 1, characterized in that the inner wall (6) of the internal space (5) is of conical configuration at least in sections.

14. The injection valve as claimed in claim 5, characterized in that a spring element (36) is provided which loads the valve closing body (8) against the sealing seat (9).

15. The injection valve as claimed in claim 5, characterized in that the valve closing body (8) has at least one pressure equalization channel (40).
